(19) United States
(12) Patent Application Publication
(10) Pub. No.: US 2014/0379412 A1
(43) Pub. Date: Dec. 25, 2014

(54) SYSTEMS AND METHODS FOR SUPPLIER SELECTION USING ROBUST OPTIMIZATION

(71) Applicant: Infosys Limited, Bangalore (IN)

(72) Inventor: Sheela Siddappa, Bangalore (IN)

(73) Assignee: INFOSYS LIMITED, Bangalore (IN)

(21) Appl. No.: 14/220,038

(22) Filed: Mar. 19, 2014

(30) Foreign Application Priority Data
Jun. 24, 2013 (IN) 2721/CHE/2013

(51) Int. Cl. G06Q 10/06

(52) U.S. Cl. CPC G06Q 10/06315
USPC 705/7.25

(57) ABSTRACT

The technique relates to a system and method for handling uncertainty in supplier selection using robust optimization. The technique involves receiving the historical data of one or more suppliers with respect to a plurality of factors from a database for selecting at least one of the one or more suppliers. After receiving the historical data, a convex hull is generated for each of the suppliers to determine a relationship between the pluralities of factors. Then adding equations which are more related to uncertainty values associated with at least one of the plurality of factors in the convex hull for each of the one or more suppliers. Thereafter, using robust optimization to determine an optimal performance level of each of the one or more suppliers with respect to the plurality of factors based on the fetched uncertainty value. Finally, selecting the suppliers based on the optimal performance level.

### FIELD

The field relates generally to supplier selection, and in particular, to a system and method for handling uncertainty in supplier selection process using robust optimization techniques.

### BACKGROUND

Supplier selection is a multi-criterion problem which includes both qualitative and quantitative factors. The world is becoming more and more a global market place, and the global environment is forcing companies to take almost everything into consideration at the same time. Increased flexibility is needed to remain more competitive and respond to rapidly changing markets. In order to select the best suppliers, it is necessary to make a tradeoff between these tangible and intangible factors, some of which may conflict.

Supply Chain Management (SCM) and strategic sourcing have been one of the fastest growing areas of management, particularly over the last decade. Under the expanded heading of logistics, these are now an integral part of company activity covering areas such as purchasing management, transportation management, warehouse management, inventory management etc. In today's environment, costs of purchasing of raw materials and components parts from external vendors (suppliers) is very important. The search for new suppliers is a continuous priority for companies in order to upgrade the variety and typology of their product range.

Supplier or vendor selection decisions are complicated by the fact that various criteria must be considered in decision making process. The analysis of criteria for selection and measuring the performance of suppliers is the main focus for the industries. A key challenge for supplier selection lies in analyzing the various factors such as time, quality, and quantity etc. during the selection process. There are various techniques such as deterministic, linear, non-linear and stochastic optimization available for supplier selection process. But the problems with these methods are that they have not explored the ways to handle the uncertainty which arises during the performance evaluation of suppliers with respect to various factors, which is reality should be considered during the supplier selection. Handling uncertainty will provide results that are close to reality and which are practically feasible. In uncertainty, handling the mismatch between the expected results and the actual outcome is the key area, which is not handled in general by the techniques such as deterministic, linear, non-linear and stochastic optimization.

### SUMMARY

The present technique's robust optimization overcomes the above-mentioned limitations by handling uncertainty in various factors during the supplier selection process. It addresses the ways to handle uncertainty in various factors that are considered for each of the suppliers during the supplier selection process. The technologies help in selecting the right set of suppliers.

According to one embodiment of the present disclosure, a method for handling uncertainty in supplier selection using robust optimization is disclosed. The technique involves receiving the historical data of one or more suppliers with respect to a plurality of factors from a database for selecting at least one of the one or more suppliers. After receiving the historical data, a convex hull is generated for each of the one or more suppliers to determine a relationship between the pluralities of factors. Then adding equations which are more related to uncertainty values associated with at least one of the plurality of factors in the convex hull for each of the one or more suppliers. Thereafter, using robust optimization method to determine an optimal performance level of each of the one or more suppliers for a given uncertainty level for each of the one or more factors provided. Finally, selecting the suppliers based on the optimal performance level.

In an additional embodiment, a system for handling uncertainty in supplier selection using robust optimization is disclosed. The system includes a capturing module, a convex hull generation module, a fetching module, an optimal performance level determination module and a selection module. The capturing module is configured to receive historical data of one or more suppliers with respect to a plurality of factors from a database for selecting at least one of the one or more suppliers. The convex hull generation module is configured to generate a convex hull for each of the one or more suppliers to determine the relationship between the pluralities of factors. The fetching module is configured to fetch an uncertainty value associated with at least one of the plurality of factors in the convex hull for each of the one or more suppliers. The optimal performance level determination module is configured to determine an optimal performance by each of the supplier for a given uncertainty in one or more selected factors using robust optimization method. The selection module is configured to select at least one of the one or more suppliers based on the performance level.

In another embodiment, a computer-readable storage medium for handling uncertainty in supplier selection using robust optimization is disclosed. The computer-readable storage medium which is not a signal stores computer executable instructions for capturing historical data of one or more suppliers with respect to a plurality of factors from a database for selecting at least one of the one or more suppliers, generating a convex hull for each of the one or more suppliers to determine the relationship between the plurality of factors, fetching an uncertainty value associated with at least one of the plurality of factors in the convex hull for each of the one or more suppliers, determining an optimal performance level of each of the one or more suppliers with respect to the plurality of factors based on the fetched uncertainty value using robust optimization method and selecting at least one of the one or more suppliers based on the performance level.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a flowchart, illustrating a method for selecting one or more suppliers in accordance with an embodiment of the present invention.

FIG. 3 is a sample graph illustrating a convex hull model during the supplier selection in accordance with an embodiment of the present invention.

FIG. 4 is a sample two-dimensional graph showing Convex hull formation based on considered factors.

FIG. 4A shows a scatter plot of data.

FIG. 4B shows a convex hull that is drawn around data with black lines.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present technique provide a system and method for handling uncertainty in supplier selection using robust optimization. This involves receiving the historical data of one or more suppliers with respect to a plurality of factors from a database for selecting at least one of the one or more suppliers. After receiving the historical data a convex hull is generated for each of the one or more suppliers to determine a relationship between the pluralities of factors. Then adding equations which are more related to uncertainty values associated with at least one of the plurality of factors in the convex hull for each of the one or more suppliers. Thereafter, using robust optimization method to determine an optimal performance level of each of the one or more suppliers with respect to the plurality of factors based on the fetched uncertainty value. Finally, selecting the suppliers based on the optimal performance level.

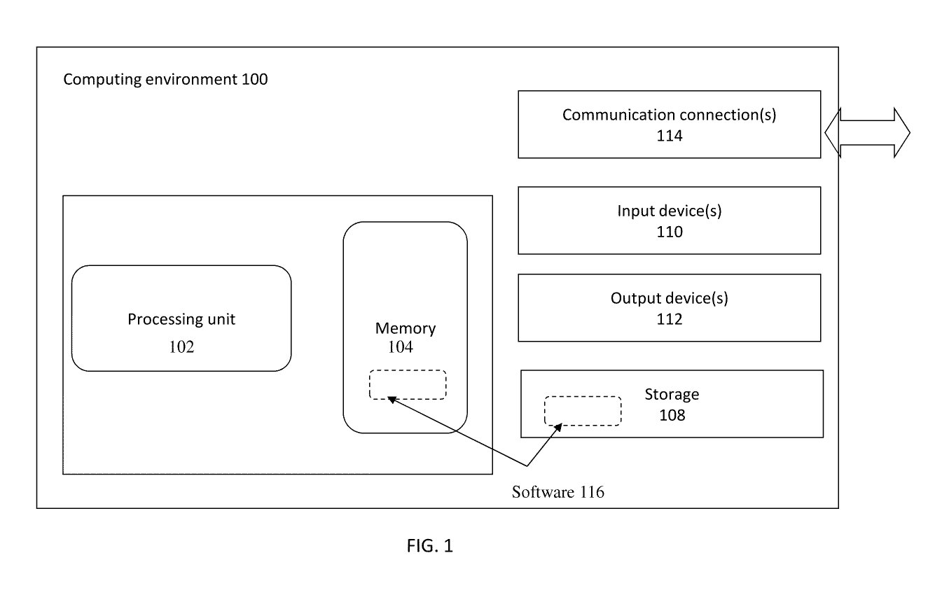

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one input unit 100 central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

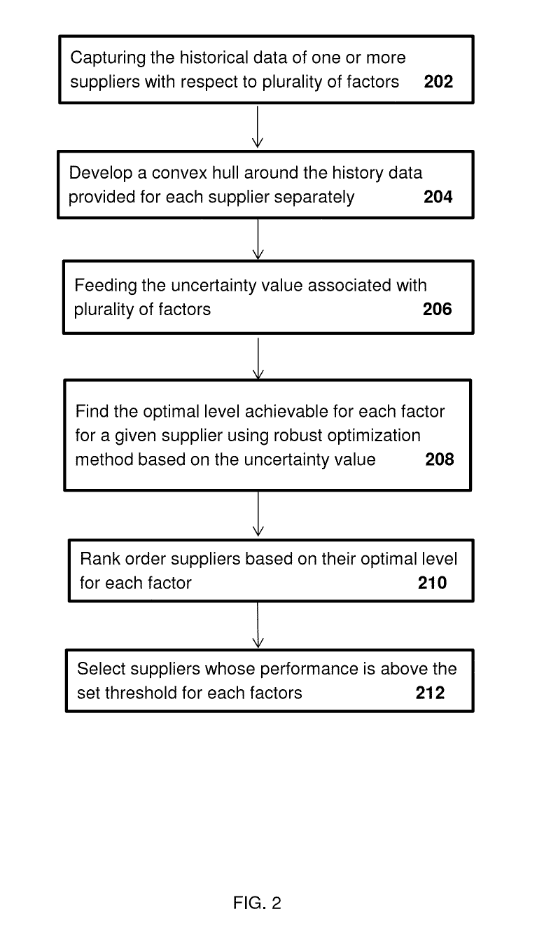

FIG. 2 is a flowchart, illustrating a method for handling uncertainty in supplier selection using robust optimization, in accordance with an embodiment of the present invention. The user input on historical data of various factors involved with respect to one or more suppliers is captured as in step 202. The various factors include but not limited to economic condition; performance measures like quality, quantity, time of delivery etc. The following table illustrates some factors which can be considered in such supplier selection. This table is a sample and does not intend to limit the scope of the disclosure. There might be some other factors as well which the organization determines or considers based on their requirement in supplier selection.

TABLE 1

| | | Performance | |
|---|---|---|---|
| | | Level | |
| Rank | Factors | Indication | Evaluation |
| 1 | Quality | 3.508 | Extreme |
| | | | Importance |
| 2 | Delivery | 3.147 | |
| 3 | Performance History | 2.998 | |
| 4 | Warranties and claim policies | 2.849 | |
| 5 | Production facilities and capacity | 2.775 | Considerable |
| | | | Importance |
| 6 | Price | 2.758 | |
| 7 | Technical capability | 2.545 | |
| 8 | Financial position | 2.514 | |
| 9 | Procedural compliance | 2.488 | |
| 10 | Communication system | 2.426 | |
| 11 | Reputation and position in | 2.412 | |
| | industry | | |
| 12 | Desire of business | 2.256 | |
| 13 | Management and organization | 2.216 | |
| 14 | Operating control | 2.211 | |
| 15 | Repair Service | 2.187 | Average |
| | | | Importance |
| 16 | Attitude | 2.120 | |
| 17 | Impression | 2.054 | |
| 18 | Packaging Ability | 2.009 | |
| 19 | Labor Relation Record | 2.003 | |
| 20 | Geographical Location | 1.872 | |
| 21 | Amount of past business | 1.597 | |
| 22 | Training Aids | 1.537 | |
| 23 | Reciprocal Arrangements | 0.610 | Slight |
| | | | Importance |

The above mentioned table is the sample of final result that helps the organizations to select the correct set of suppliers based on their needs.

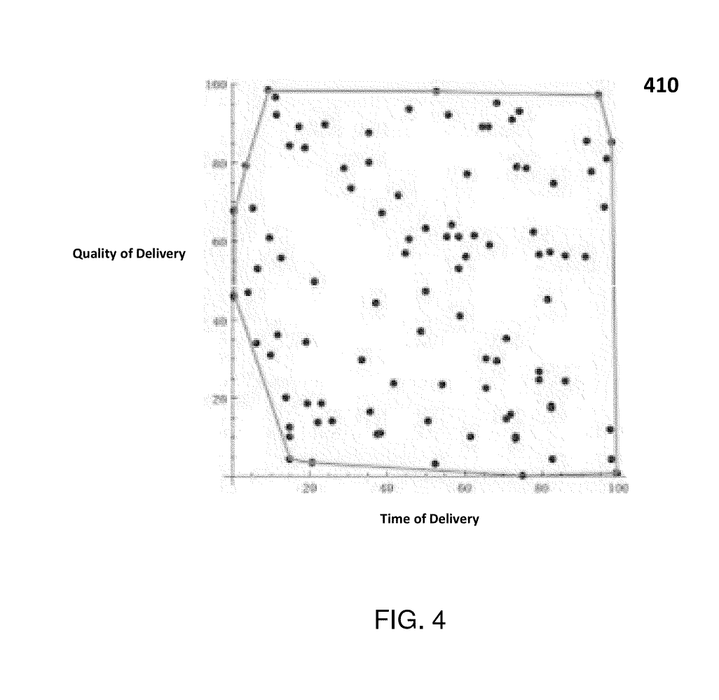

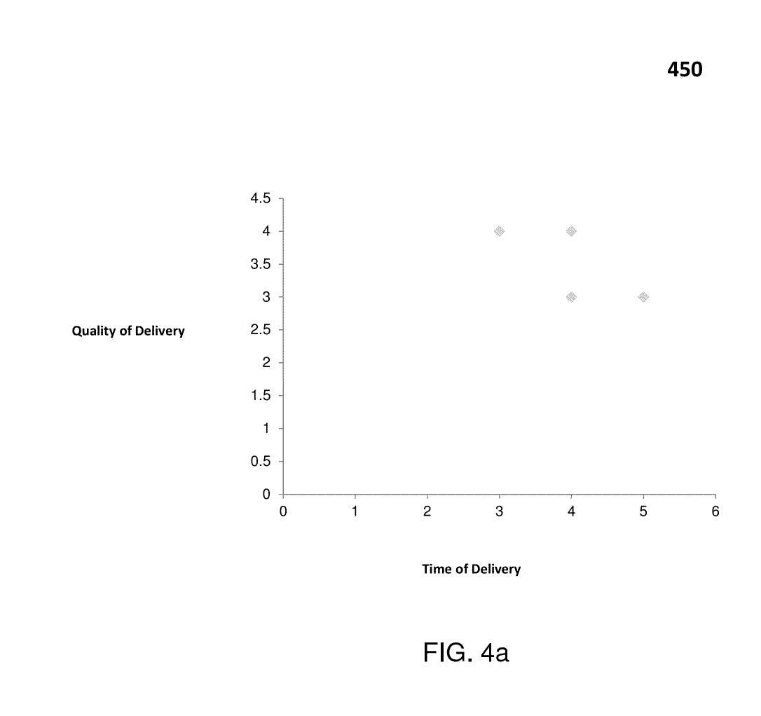

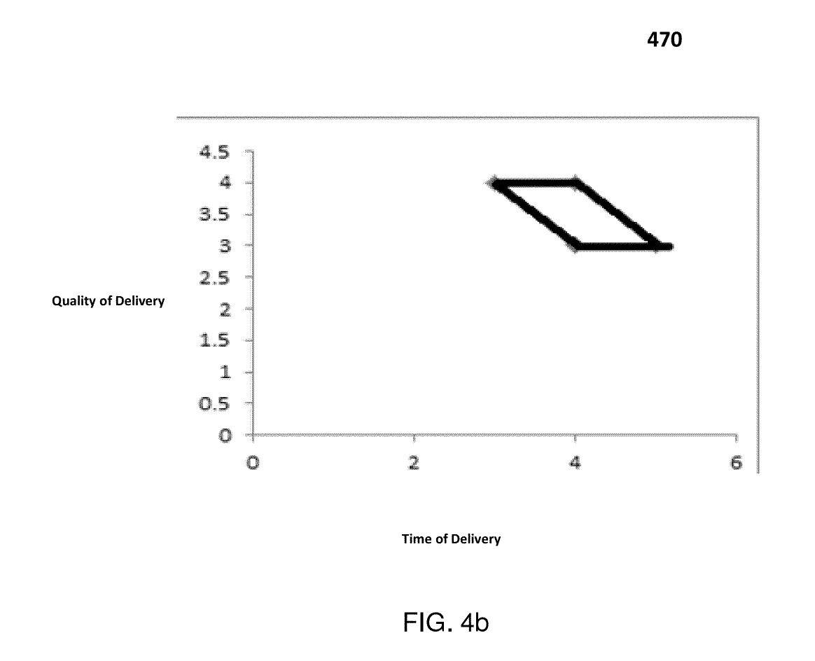

At the next step 204, the convex hull is created based on some of the factors that have been listed in Table 1. In general, a convex hull is the smallest convex polygon that contains every point of the set S. A polygon P is convex if and only if, for any two points A and B inside the polygon, the line segment AB is inside P. A sample graph (FIG. 4) has been created which shows a 2-D convex hull with 2 factors such as quality of delivery and time of delivery. From the graph, it is understood that the convex hull connects all the points (data) outer plots in such a way that there is a connection between any 2 points. In this graph each line is considered as an equation. These equations help in understanding the relation between the factors considered. A convex hull can be drawn by considering ‘n’ number of factors as well. Then the resultant will be an n-dimensional convex hull. The convex hull is repeated for each of the supplier's history data. The convex hull helps in understanding the relations between various factors.

In step 206, uncertainty values/levels for those factors are fed and appended to the result of step 204. Once it is appended then in step 206 based on the uncertainty value, the performance optimization is done using robust optimization technique. Robust optimization is a field of optimization theory that deals with optimization problems in which a certain measure of robustness is sought against uncertainty that can be represented as deterministic variability in the value of the parameters of the problem itself and/or its solution. Robust Optimization is an uncertainty modeling approach suitable for a situation where the range of the uncertainty is known and not necessarily the distribution (depending on the industry, this could be price, temperature, demand, etc.). Typically some inputs take an uncertain value anywhere between a fixed minimum and a maximum. Solutions will be feasible for all the constraints when the inputs drift within the uncertainty ranges. The robustness of the decision is measured in terms of the best performance against all possible realizations of the parameters values.

In step 210, the suppliers are ranked based on their performance optimization score. The score can be evaluated in terms of numbers/percentage according to the convenience of the organization/industry.

In step 212, the ranked suppliers are selected based on the threshold range that has been fixed up/selected by the organization/industry. The table 1 shows up the sample data of how the performance evaluation has resulted in the form of the ranking with respect to various supplier data. So, based on the performance level indication score the suppliers are ranked and the selection happened for top ‘n’ suppliers as per the standard set up by the organization/industry. A sample example is given below to better understand the whole process of robust optimization technique in handling uncertainty.

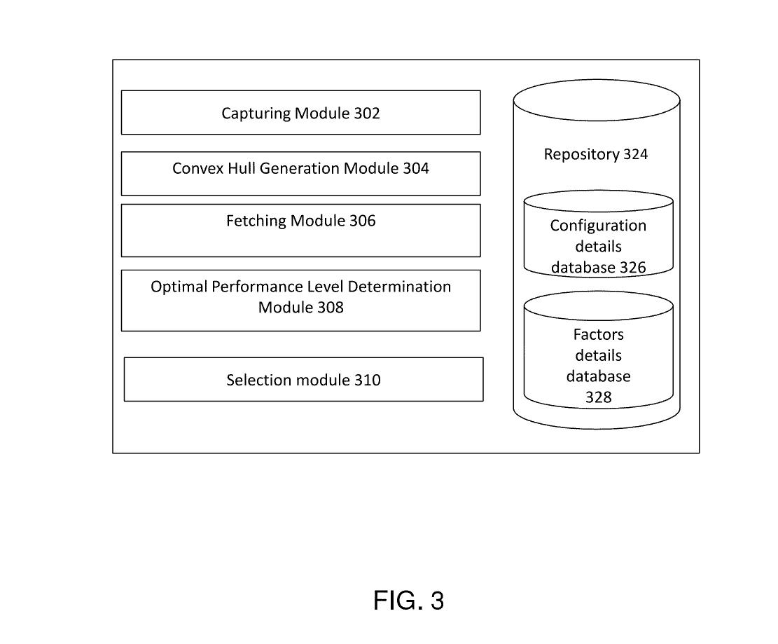

FIG. 3 is a block diagram illustrating a system for handling uncertainty in supplier selection using robust optimization, in accordance with an embodiment of the present invention. More particularly, the system includes a capturing module 302, a convex hull generation module 304, a fetching module 306, an optimal performance level determination module 308 and a selection module 310. The capturing module 302 is configured to capture the user input regarding the historical data for one or more suppliers with respect to factors taken from the database. The convex hull generation module 304 is configured to generating a convex hull for each of the one or more suppliers to determine a relationship between the pluralities of factors. The fetching module 306 is configured to provide the uncertainty factor which is associated with the plurality of factors either in terms of a value/percentage into the convex hull for one or more suppliers. An optimal performance level determination module 308 is configured to determine an optimal performance level of each of the one or more suppliers with respect to the plurality of factors based on the fetched uncertainty value using the robust optimization approach. Once the performance level is measured the suppliers are rank ordered based on the same. Each organization can have their individual threshold criteria to rank order the supplier/suppliers. The selection module 310 is configured to select one or more suppliers based on the ranking system determined using the threshold level.

FIG. 4 is the sample two-dimensional graph 410 which shows the Convex hull formation based on the factors considered. Here the two factors that are considered are quality and time of delivery. Convex hull analyses the data and it demonstrates the relation between quality of delivery and time of delivery. Once the Convex hull is formed then as the next step the uncertainty values for some of the factors are captured and appended into the previous step. Based on this new set, the robust optimization technique is applied to evaluate the optimized performance of each supplier. These steps are repeated for each of the supplier and the final results are sorted in an order to find out the best supplier. Let ABC have three different suppliers X, Y and Z supplying them product alpha. Performance of X, Y and Z for various attributes are as the sample data below. The Scores are in a 1-5 scale, with 1 being low and 5 high performances.

TABLE 2

| Factor | X | Y | Z |
|---|---|---|---|
| Quality (q) | 4 | 1 | 4 |
| Time of Delivery (t) | 3 | 4 | 4 |
| Quantity (qn) | 2 | 3 | 3 |
| . . . | . . . | . . . | . . . |

The better way to understand the relation between quality, time and quantity for each supplier is using the convex hull. Let the overall performance of a supplier be a weighted function: p=w1_q+w2_t+w3_qn. The need for the relation is as per the factor consideration.

Supplier x can get good quality but might take lot of time to achieve that high quality. In reality it will be difficult to achieve high quality in less time. If quality and time are very good, then another factor like quantity might be low. So there is a tradeoff between some selected factors. But, company ABC might be interested in all the factors. To understand the relation in better terms, history of data is required. Here is a sample data for supplier X.

TABLE 3

| | Performance on | Performance on “Time of |
|---|---|---|
| Time (month and year) | Quality (q) | Delivery”(t) |
| June 2001 | 4 | 3 |
| June 2002 | 4 | 4 |
| December 2002 | 4 | 3 |
| June 2003 | 4 | 3 |
| December 2003 | 3 | 4 |

FIG. 4a shows the scatter plot of the above data.

FIG. 4b shows a convex hull which is drawn around the data with black lines. Each facet is an equation of the form ax+by +c. As there are four facets encompassing the data, there will be four equations to help understand the relation. Here ‘P’ is the performance. Eg:

p=a1_{—}q+b1_{—}t+c1

p=a2_{—}q+b2_{—}t+c2

p=a3_{—}q+b3_{—}t+c3

p=a4_{—}q+b4_{—}t+c4

To introduce uncertainty in one or more factors, the obtained new set of equations based on Bertsimas's method is taken into consideration. For example, to introduce uncertainty in quality alone: Here a1, a2, a3 and a4 are uncertain.

Let the uncertainty equations based on Bertsimas method is as follows.

d1_{—}a1<=1

d2_{—}a2<=1

d3_{—}a3<=1

d4_{—}a4<=1

d1+d2+d3+d4<=4

Then add the four constraints to our original set of constraints and write the dual of the linear programming problem. The objective is to know the robust performance of supplier X given uncertainty in q. Finally the new set of equations with an objective function is obtained as follows. The performance has to be maximized such that

$$a1\_q + b1\_t <= r 1$$

$$a2\_q + b2\_t <= r 2$$

$$a3\_q + b3\_t <= r 3$$

$$…$$

$$an\_q + bn\_t <= rn$$

Solving the above problem using robust optimization method will provide us the solution of the form. Maximum performance of supplier X given 25% uncertainty is P=4. The above procedure is repeated for other two suppliers as well. Let the overall performance score for Y and Z is 3.5 and 4.3 respectively. As the next step, the suppliers are rank ordered based on their score. Based on the table, if company ABC plans to select only two of the three suppliers in the next year, it will now understand that suppler Z and X will perform well and can select them.

TABLE 4

| | | Overall performance |
|---|---|---|
| Rank | Supplier | score |
| 1 | Z | 4.3 |
| 2 | X | 4 |
| 3 | Y | 3.5 |

One or more computer-readable media (e.g., storage media) or one or more processor-readable media (e.g., storage media) can comprise computer-executable instructions causing a computing system (e.g., comprising one or more processors coupled to memory) (e.g., computing environment 100 or the like) to perform any of the methods described herein. Examples of such computer-readable or processor-readable media include magnetic media, optical media, and memory (e.g., volatile or non-volatile memory, including solid state drives or the like).

The above-mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer-implemented method for selecting one or more suppliers, the method comprising:
capturing historical data of one or more suppliers with respect to a plurality of factors from a database for selecting at least one of the one or more suppliers;
generating a convex hull for each of the one or more suppliers to determine a relationship between the plurality of factors;
fetching an uncertainty value associated with at least one of the plurality of factors in the convex hull for each of the one or more suppliers;
using robust optimization method to determine an optimal performance level for each of the one or more suppliers with respect to the plurality of factors based on the fetched uncertainty value; and
selecting at least one of the one or more suppliers based on the optimal performance level.

2. The method as claimed in claim 1, wherein the selection of at least one of the one or more suppliers involves ranking of the one or more suppliers based on the optimal performance level with respect to the plurality of factors.

3. The method as claimed in claim 2, wherein the ranking of at least one of the one or more suppliers involves setting up a threshold performance level for the one or more suppliers.

4. The method as claimed in claim 1, wherein the plurality of factors involves quantity, delivery, warranty, price, technical capability, production facility and performance history.

5. A system for selecting one or more suppliers, the system comprising:
a processor in operable communication with a processor readable storage medium, the processor readable storage medium containing one or more programming instructions whereby the processor is configured to implement:
a capturing module configured for capturing historical data of one or more suppliers with respect to a plurality of factors from a database for selecting at least one of the one or more suppliers;
a convex hull generation module configured to generate a convex hull for each of the one or more suppliers to determine the relationship between the plurality of factors;
a fetching module configured to fetch an uncertainty value associated with at least one of the plurality of factors in the convex hull for each of the one or more suppliers;
a optimal performance level determination module configured to determine an optimal performance level for plurality of factors in the convex hull for each of the one or more suppliers using robust optimization method; and
a selection module configured to select at least one of the one or more suppliers based on the performance level.

6. The system as claimed in claim 5, wherein the selection module comprises a ranking module for ranking of the one or more suppliers based on the optimal performance level with respect to the plurality of factors.

7. The system as claimed in claim 6, wherein the ranking module is configured for setting up a threshold level for each of the one or more suppliers with respect to their performance level.

8. The system as claimed in claim 5, wherein the capturing module comprises a plurality of factors that involves quantity, delivery, warranty, price, technical capability, production facility and performance history.

9. A computer-readable storage medium, that is not a signal, having computer executable instructions stored thereon for selecting one or more suppliers, the said instructions comprising:
instructions for capturing historical data of one or more suppliers with respect to a plurality of factors from a database for selecting at least one of the one or more suppliers;
instructions for generating a convex hull for each of the one or more suppliers to determine the relationship between the plurality of factors;
instructions for fetching an uncertainty value associated with at least one of the plurality of factors in the convex hull for each of the one or more suppliers;
instructions for determining an optimal performance level of each of the one or more suppliers with respect to the plurality of factors based on the fetched uncertainty value using robust optimization method; and
instructions for selecting at least one of the one or more suppliers based on the performance level.

10. The computer-readable storage medium as claimed in claim 9, wherein the instructions for selection involve at least one of the one or more suppliers involves ranking of the one or more suppliers based on the optimal performance level with respect to the plurality of factors.

11. The computer-readable storage medium as claimed in claim 10, wherein the instructions for ranking involve setting up a threshold level for each of the one or more suppliers with respect to their performance level.

12. The computer-readable storage medium as claimed in claim 9, wherein the plurality of factors involves quantity, delivery, warranty, price, technical capability, production facility and performance history.
